(19) United States
(12) Patent Application Publication
(10) Pub. No.: US 2010/0156357 A1
(43) Pub. Date: Jun. 24, 2010

(54) System and method for charging rechargeable batteries

(76) Inventors: Ibrahim Abou Hamad, Tallahassee, FL (US); Mark Alan Novotny, Starkville, MS (US); David Owen Wipf, Starkville, MS (US)

Correspondence Address: Larry A. Schemmel;Office of the Attorney General, P.O. Box 1850, Jackson, MS, 39215-1850, US

(21) Appl. No.: 12/590,717

(22) Filed: Nov. 12, 2009

Related U.S. Application Data
(60) Provisional application No. 61/199,176, filed on Nov. 13, 2008.

(51) Int. Cl. H02J 7/04; H02J 7/16

(52) U.S. Cl. 320/157; 320/162; 320/161

(57) ABSTRACT

The present invention provides for a novel system and method of charging rechargeable batteries of all types, sizes, and voltages, including lithium-ion batteries, through the application of an oscillatory or other time-dependent voltage and/or current prior to, following, and/or simultaneously with the application of a constant voltage and/or current during the charging phase of the rechargeable battery. The novel battery charging method results in a reduction in charging time and an increase in discharge capacity and cell lifetime without adversely affecting the capacity of the battery.

### CROSS-REFERENCE TO RELATED APPLICATION

This application claims priority from U.S. Provisional Patent Application Ser. No. 61/199,176 filed Nov. 13, 2008. The entirety of that provisional application is incorporated herein by reference.

### FIELD OF THE INVENTION

This invention relates to the field of rechargeable batteries and more specifically to the field of charging rechargeable batteries and involves a novel system and method for charging rechargeable batteries of all voltages and sizes through the application of an oscillatory or other time-dependent voltage and/or current simultaneously with a constant voltage and/or current during the charging phase of the rechargeable battery.

### BACKGROUND OF THE INVENTION

The present invention in a preferred embodiment utilizes an oscillatory or other time-dependent voltage and/or current simultaneously with a constant voltage and/or current during the charging phase of any type of rechargeable battery to efficiently reduce the charging time required without adversely affecting the lifetime or capacity of the battery itself.

Currently existing methods of charging rechargeable batteries, including lithium ion batteries, involve using only constant current and/or constant voltage techniques. During charging, the temperature or other variables may be monitored and the charging scheme is regulated depending on these variables to adjust the value of the charging current and/or voltage to a new constant value(s) or to switch charging “on and off states.” See U.S. Pat. Nos. 7,378,819; 6,707,272; 6,204,634; 6,040,684; and 5,726,554. Likewise, U.S. Pat. Nos. 6,022,640 and 5,994,874 disclose a lithium battery assembly and charging method and a battery charger with battery pack of different charging voltages, respectively. However, the system and method of the present invention utilizes the constantly varying characteristic of the charging field without increasing the voltage (i.e., the voltage difference between the cathode and the anode of the battery) beyond the critical voltage, the critical voltage being defined as the manufacturer-defined maximum safe operating voltage, and is much simpler to implement than current methods.

### SUMMARY OF THE INVENTION

The present invention provides for a novel system and method of charging rechargeable batteries, including lithium-ion batteries, of all voltages and sizes. The system and method involves a time-dependent scheme based on the application of an oscillatory or other time-dependent voltage and/or current simultaneously with a constant voltage and/or current during the charging phase of the rechargeable battery. Large-scale molecular dynamics computer simulations of lithium ions intercalating between graphite sheets in the presence of an oscillatory applied electric field were performed. It was found that intercalation proceeded much faster with the applied oscillatory field than with only a constant applied field, considering the unphysical parameters required in order to perform simulations in the tens to thousands of nanoseconds regime. Experimental studies of lithium-ion batteries using the standard charging method were compared with the oscillatory field method of the present invention. It was found that the charging time and/or discharge capacity of a rechargeable battery with the oscillatory field method of the present invention could be reduced by substantial factors. In particular, improvements were found in un-optimized investigations in laboratory explorations of ten percent or larger and from extrapolations based on the large-scale molecular dynamics simulations of factors of two or larger. Moreover, no adverse effects of the novel charging method were found in the battery lifetime.

The present invention involves large-scale molecular dynamics simulations of the anode half-cell of a lithium-ion battery. The system is composed of a stack of graphite sheets representing the anode, ethylene carbonate and propylene carbonate molecules as the electrolyte, and lithium and hexafluorophosphate ions. The simulations are done in the NVT ensemble (constant particle number N, constant volume V, and constant temperature T) and at room temperature. The inventors explored different charging schemes. The inventors started with the lithium and hexafluorophosphate counter-ions in different initial positions and velocities, and calculated the time for the lithium ions to intercalate into the spaces between the graphite sheets. These intercalation simulations were run to many hundreds of nanoseconds in time. One charging scheme explored was normal charging whereby intercalation was enhanced by electric charges on the graphitic sheets. Another charging mechanism utilized an externally-applied oscillatory electric field of amplitude A and frequency f. The simulations were performed on 2.6 GHz Opteron processors using 160 processors at a time. The simulation results showed a vast improvement in the intercalation time in the lithium ions and therefore in the charging time for lithium-ion batteries using the charging mechanism of the present invention that utilizes the externally-applied oscillatory electric field.

### BRIEF DESCRIPTION OF THE DRAWINGS

These drawings accompany the detailed description of the invention and are intended to illustrate further the invention and its advantages:

FIG. 1 is a representation of the model system used in the molecular dynamics simulations; the model system is composed of four graphite sheets representing the anode.

FIG. 2 is a graphical illustration of the root-mean-square displacement (RMSD) of lithium ions as a function of time.

FIG. 3 is a graphical illustration of the Arrhenius-like dependence of the intercalation time on the amplitude A of the additional oscillating field.

FIG. 4 is a graphical illustration of the discharge capacity and charge time of a cell charged by the conventional (CCCV) method compared to the CCACV method of the present invention (at 100 Hz).

FIG. 5 is a graphical illustration of the discharge capacity and charge time of a cell charged by the conventional (CCCV) method compared to the CCACV method of the present invention (at 1000 Hz).

### DETAILED DESCRIPTION OF THE INVENTION

The present invention provides a novel system and method for charging rechargeable batteries, including lithium-ion batteries, of all voltages and sizes and utilizes in a preferred embodiment a time-dependent scheme based on the application of an oscillatory or other time-dependent voltage and/or current simultaneously with a constant voltage and/or current during the charging phase of the rechargeable battery. Moreover, the invention efficiently reduces the charging time required without adversely affecting the lifetime or capacity of the battery. This invention can be used with other methods that in piece-wise fashion change a constant voltage and/or current during charging. Furthermore, using measurements from the battery to be charged (measurements including, but not limited to, the temperature), faster charging may be obtained by optimizing additional parameters rather than only the value of the piece-wise constant voltage and/or current. These additional parameters include, but are not limited to, the amplitude and frequency and waveform of the applied oscillating or other time-dependent voltage and/or current.

### Introduction

Traditionally, rechargeable batteries are charged using a charging cycle that is composed of a constant current part (CC) and a constant voltage part (CV) with some variation on this scheme to control the current delivered and for safety measures. The system and method of the present invention discloses a novel charging method that is capable of charging a battery to a higher state of charge more rapidly than via traditional methods, with the potential for much shorter charging times after optimizing the control parameters of the new charging scheme. Moreover, the present invention has no negative effects on the battery capacity or cycle lifetime. Finally, while the present invention offers an improvement in charging time, its implementation additionally requires no major changes to current chargers available in the marketplace. The detailed description that is presented herein discloses the novel charging system and method of the present invention as well as large scale molecular dynamics simulations and experimental results that support the invention.

### Time-Dependent Charging Scheme

While other existing charging schemes try to keep the current and/or voltage constant for the majority of the charging time (or constant in a piece-wise fashion), the method and system of the present invention relies on a continuously-varying charging field. We will define and refer to this continuously-varying charging electric field as an oscillatory field component, but this should be taken to mean any varying charging field, whether it is oscillatory or random or otherwise continually changing in time. A random electrical field produces electrical quantities having purely random amplitudes and time durations. The amplitude is confined between two defined limits. The charging scheme described herein is applicable for any type of waveform including, but not limited to, sinusoidal, square-wave, or saw-tooth waveforms. The novel concept is to rely on the oscillatory nature of the charging field in order to improve the diffusion as well as the intercalation times in lithium-ion (Li-ion) or any other rechargeable battery. Our simulations and experimental results were completed using Li-ion batteries; however, this fact does not and should not limit the system and method of the present invention to only that type of rechargeable battery. The system and method disclosed herein is and should be applicable to other types and kinds of rechargeable batteries. As distinguished from other charging methods, such as the “pulse charging” method where the charging field is either on or off (in other words, piece-wise constant), the method of the invention uses, in addition to a constant charging field, an oscillatory or random (time-dependent) component at a relatively high frequency shown algebraically as follows:

U(t)=U_{c}+Uₒ(t)

where U_{c} is the constant charging field and Uₒ(t) is the oscillatory or random field. Without loss of generality, the charging field of the present invention replaces all or part of the constant voltage part (CV) of the charging regime and may precede or follow the CV step. This does not limit the simultaneous or separate application of such an oscillatory or random (continually changing in time) field to another part of the charging scheme such as the constant current part (CC). In such a case, the charging field would be composed of a constant current part (CC) with a superimposed oscillatory or random current. This charging regime would replace all or part of the constant current part (CC) of the charging regime and may precede or follow the CC step.

### Molecular Dynamics Simulations

Large-scale molecular dynamics simulations of the anode half cell of a lithium-ion battery were used to test the novel charging method and system of the present invention. Molecular dynamics is based on solving the classical equations of motion for a system of N atoms. The equation of motion for atom i is shown as follows:

$${F}_{i} ( t ) = - \frac{\partial {E}_{p}}{\partial {r}_{i} } = {m}_{i} \frac{\partial {v}_{i}}{\partial t} = {m}_{i} \frac{{\partial }^{2} {r}_{i}}{\partial {t}^{2}} ,$$

where Fᵢ is the force on atom i, Eₚ is the potential energy, and rᵢ, vᵢ, and mᵢ, are the position, velocity, and mass of the iₜₕ atom, respectively.

The General Amber Force Field (GAFF) was used to approximate the bonded interactions, while the simulation package Spartan was used to approximate the point charges for each of the atoms. To simulate the constant charging field U_{c}, the charge on the carbon atoms of the graphite sheets was set to −0.0125 e per atom. The simulation packages NAMD and VMD were used for simulation and visualization, respectively.

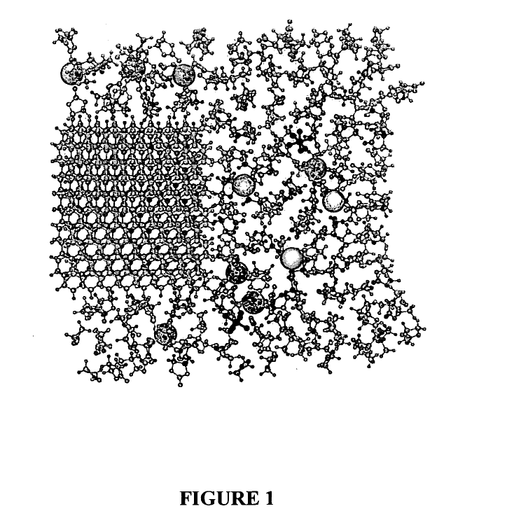

The model system is composed of four graphite sheets representing the anode containing 160 carbon atoms in each graphitic sheet, two PF₆⁻ ions (black), and ten Li⁺ ions (silver spheres), in an electrolyte made of 69 propylene carbonate and 87 ethylene carbonate molecules (see FIG. 1). The end atoms at one side of the graphite sheets were fixed.

### Simulation Results

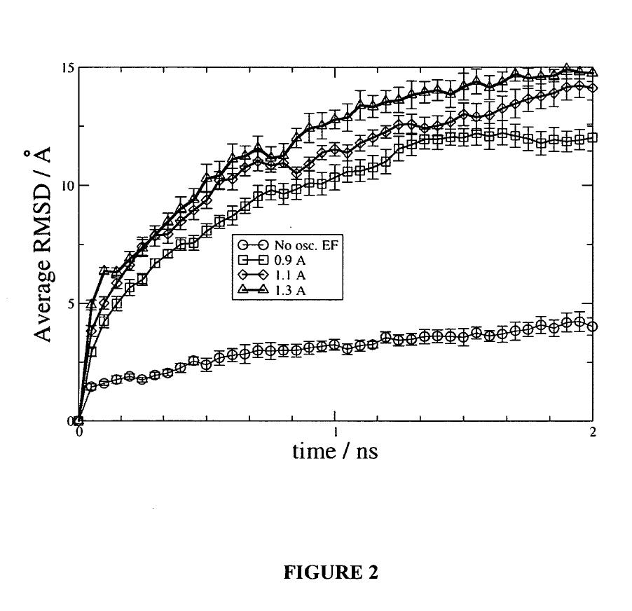

After energy minimization, the system was run in the NPT ensemble (constant particle number N, constant pressure P, and constant temperature T) until it reached its equilibrium volume. To study the effect of adding the oscillating field Uₒ(t), simulations with a constant field (Uₒ(t)=0) and with an additional square wave oscillating field shown as follows:

$${U}_{o} ( t ) = \{ \frac{A for k ( \frac{1}{2 f} ) < t < ( k + 1 ) ( \frac{1}{2 f} ) and k is even}{- A for k ( \frac{1}{2 f} ) < t < ( k + 1 ) ( \frac{1}{2 f} ) and k is odd} \}$$

where A=5 kCal/mol is the amplitude and f=25 GHz is the frequency, were compared running in the NVT ensemble (constant N, T, and volume V). The direction of the Uₒ(t) was perpendicular to the plane of the graphite sheet, but simulations with other orientations of the field gave similar results. Simulations without the additional Uₒ(t) showed no intercalation of Li-ions for the time scales that could be simulated and showed only slow diffusion towards the anode (the Li-ions stayed randomly distributed within the electrolyte). However, the addition of the oscillating electric field drastically increased the diffusion (see FIG. 2) and also led to some of the Li-ions being intercalated within the graphite sheets. FIG. 2 shows the Root-Mean-Square Displacement (RMSD) of lithium ions as a function of time. Diffusion is much faster with the additional oscillating electric field (amplitude 5 kCal/mol, frequency 25 MHz). The notation 0.9 AMP means the amplitude is 0.9 A=4.5 kCal/mol.

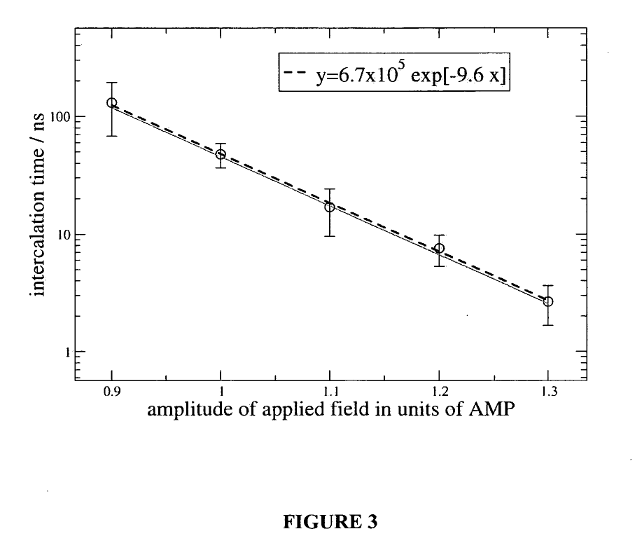

Simulations with several values of the amplitude of the oscillating field were run. These simulations showed an Arrhenius-like dependence of the intercalation time on the amplitude (see FIG. 3). FIG. 3 graphically shows the Arrhenius-like dependence of the intercalation time on the amplitude A of the additional oscillating field. The x-axis is in units of AMP=5 kCal/mol. Extrapolating the fit in FIG. 3 to zero amplitude for the oscillatory field leads to an intercalation time, of 6.7×10⁵ ns, much longer than can be currently efficiently simulated using molecular dynamics methods on this system.

The above-mentioned simulations suggested that applying an additional oscillatory field to the constant charging field would decrease the charging time of a battery and likely also increase the battery capacity. However, due to the limitations of atomistic molecular dynamics simulations, in that only very short timescales can be simulated, the amplitude A and frequency f used were of necessity far from what could reasonably be applied to an actual rechargeable battery. Consequently, we tested this idea experimentally as discussed herein.

### Experiments

To test our theoretical predictions, charging methods incorporating an oscillating charging component were developed. Commercially available cylindrical Li-ion cells (Type 18500, Tenergy) with a nominal 3.7 V, 1.40 Ah rating were used for testing. Two charging methodologies were compared: the conventional method and a method based on oscillating charging. The conventional charging method—known as CCCV—applies a constant charging current (i.e., CC) until the battery reaches a terminating charging voltage of between 3.7 V to 4.25 V, whereupon a constant voltage (CV) equal in value to the terminating charging voltage of the CC step is applied. The CV step is continued until the cell current decreases to a predetermined level, which is ultimately related to the battery capacity. In the experiments described herein, the cells were charged in the CC mode at 1.40 A (1 C rate). The C rate is the amount of current required to nominally charge a cell in 1 h (hour) time. The terminating charging voltage was 4.20 V. The CV voltage was 4.20 V and the end charging current was 28 mA (i.e., 2% C). The oscillating charging method was identical to the CCCV method except an oscillating voltage step (i.e., ACV) was interposed between the CC and CV steps. Following the CC step, an ACV step, consisting of a square wave of 50 mV amplitude and 50% duty cycle was superimposed on a steady voltage of 4.15 V to produce the ACV charging voltage cycling between 4.15 V and 4.20 V. The ACV step was applied for 30 minutes. Next, a terminal CV step of 4.20 V was applied until the cell current reached 28 mA. Thus, we refer to the charging method of the present invention involving superimposition of an oscillating charge as the CCACV method. In the CCACV method, a frequency of 10 to 1000 Hz was used. However, the external continuously-varying charging electric field can be applied at a frequency of about 10 Hz to about 10,000 Hz, depending upon what type of rechargeable battery is being charged. Using the method of the present invention, the voltage difference between the cathode and the anode of the battery was maintained below the critical voltage, the critical voltage being defined as the manufacturer-defined maximum safe operating voltage of the battery.

Following cell charging and after a rest period of 30 minutes, the cell was discharged at −1.40 A (i.e., a 1 C rate) to a terminating voltage of 2.75 V. A rest period followed discharge prior to any subsequent charge cycle. Finally, in comparing between charging methods, care was taken to ensure that each cell underwent the same number of charge/discharge cycles and that previously-unused cells were used for comparisons. Actual charge/discharge testing was done on the Solartron 1470E battery test set and CellTest Software (Solartron Analytical, Farnborough England), which permitted simultaneous charging and discharging tests of the cells undergoing CCCV or CCACV charging. Cell temperatures were measured with K-type thermocouples attached with adhesive tape to the body of the cell.

A concern was that the CCACV charging of the present invention might present a hazard or otherwise decrease the cell lifetime. However, Table 1 shows that, for CCACV charging as described above using different AC frequencies, the decrease in cell lifetime with charge/discharge cycle is no worse than that with conventional CCCV charging. In contrast, CCACV charging at 100 Hz shows improved capacity retention compared to CCCV charging. Temperatures were monitored during the charging and discharging process and were always within 1-3° C. between the CCCV and CCACV cells, giving no evidence that the CCACV charging method of the present invention produces any safety concern.

TABLE 1
Capacity Loss with Cycling

| | | Capacity Loss | Capacity Loss |
|---|---|---|---|
| Cell | Charging Mode | at 370 Cycles | at 500 Cycles |
| J | CCCV | 79% | 71% |
| K | CCACV (1000 Hz) | 77% | — |
| L | CCACV (100 Hz) | 88% | 80% |
| M | CCACV (10 Hz) | 82% | — |

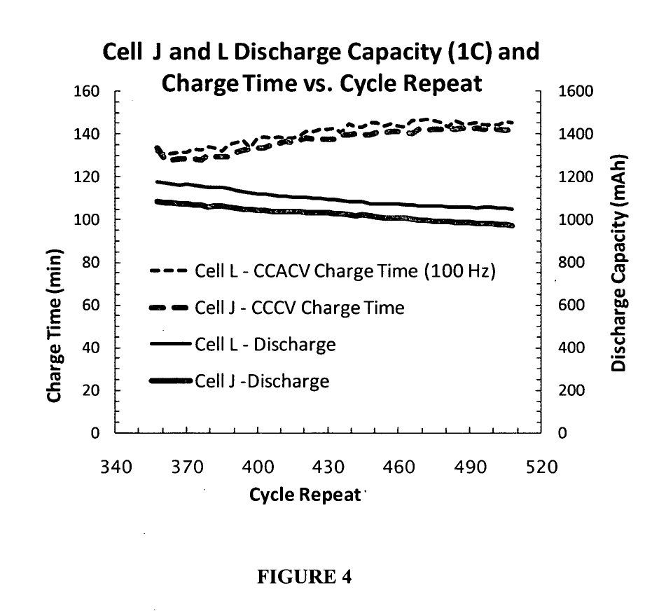

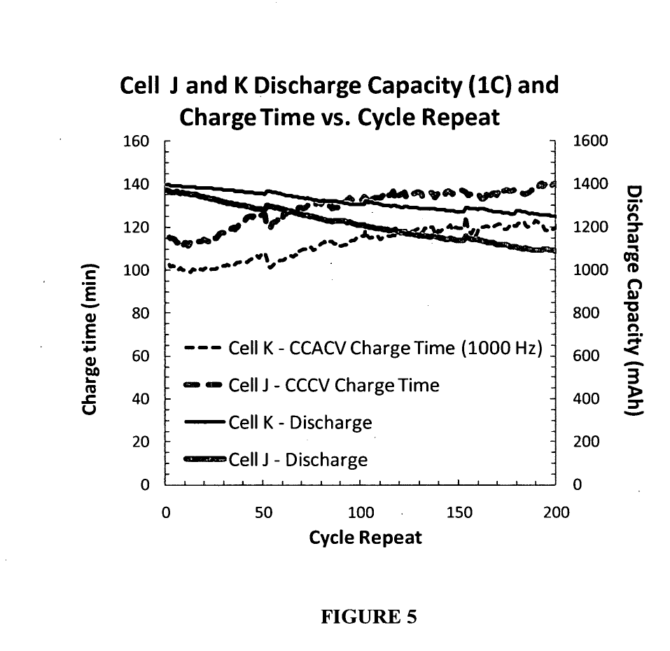

In FIG. 4, a comparison is made between the ultimate discharge capacity (at 1 C) between a cell charged with the conventional CCCV mode (cell J) and a cell charged with the CCACV mode of the present invention (cell L, 100 Hz) using the procedure described herein. As FIG. 4 indicates, an improvement in capacity on the order of 8% is present over a large number of charging and discharging cycles. There is a slight increase in the total charging time of about 2% with the CCACV mode. FIG. 5 shows an increase in discharge capacity (at 1 C) between a cell charged with the CCCV mode (cell J) and a cell charged with the CCACV mode but with different ACV frequency (cell K, 1000 Hz). Here the discharge capacity is as much as 14% larger with the CCACV mode, however, at a cost of 19% increase in charging time. Note that the increased discharge capacity obtained here suggests that a reduction in charging time can be obtained with the CCACV mode charging of the present invention while retaining equal or greater capacity than is generated with conventional CCCV mode charging.

Although no effort was made to optimize the amplitude, frequency, or shape of the oscillating charging step, the experimental data set indicates that the CCACV charging method and system of the present invention improves cell lifetime (c.f. Table 1), provides a higher cell discharge capacity, and potentially reduces cell charging time (FIGS. 4 and 5).

### SUMMARY

The computational and experimental studies show multiple advantages of the new system and method of charging rechargeable batteries of the present invention disclosed herein. While this system and method decreases the charging time significantly, there is also minimal to no loss in battery capacity. The potential for further improvement is great as the frequency and amplitude parameter space is explored for particular rechargeable battery types. Although the simulations and experiments of the present invention utilized Li-ion batteries and the present invention was tested experimentally by adjusting the CV part alone, this should and does not limit the method of the invention to the one type of battery or part of the charging scheme tested. The system and method of the present invention is applicable to any type or kind of battery, and for any voltage, and as well is applicable during other parts of the charging scheme such as the CC part. Additionally, the implementation of such a system and method does not require major changes to existing chargers and would require no changes to consumer usage of the batteries. Finally, the implementation can be incorporated with other charging systems that have piece-wise-in-time constant current and/or voltage components that are changed depending on measured parameters including, but not limited to, the temperature of a battery, and in particular such measured quantities can now be used to modify in time both the applied piece-wise constant current and/or voltage and other parameters including, but not limited to, the amplitude and/or frequency and/or waveform of the applied voltage and/or current.

The above detailed description is presented to enable any person skilled in the art to make and use the invention. Specific details have been revealed to provide a comprehensive understanding of the present invention, and are used for explanation of the information provided. These specific details, however, are not required to practice the invention, as is apparent to one skilled in the art. Descriptions of specific applications, analyses, and/or calculations are meant to serve only as representative examples. Various modifications to the preferred embodiments may be readily apparent to one skilled in the art, and the general principles defined herein may be applicable to other embodiments and applications while still remaining within the scope of the invention. There is no intention for the present invention to be limited to the embodiments shown or described and the invention is to be accorded the widest possible scope consistent with the principles and features disclosed herein.

What is claimed is:

1. A method of charging a rechargeable battery, the method comprising:
applying an electric charge to the anode of the battery for enhancing ion diffusion towards and intercalation into the anode;
applying at least one external continuously-varying charging electric field to the anode of the battery for enhancing ion diffusion towards and intercalation into the anode; and
maintaining the voltage difference between the cathode and the anode of the battery below the critical voltage of the battery.

2. The method of claim 1, wherein the at least one external continuously-varying charging electric field is continually changing in time.

3. The method of claim 2, wherein the at least one external continuously-varying charging electric field is an oscillatory electric field.

4. The method of claim 2, wherein the at least one external continuously-varying charging electric field is a random electric field.

5. The method of claim 1, wherein the at least one external continuously-varying charging electric field comprises a time-dependent voltage, a time-dependent current, or combinations thereof.

6. The method of claim 5, wherein the method further comprises optionally applying a fixed value constant electric field and at least one external continuously-varying charging electric field to the anode of the battery.

7. The method of claim 6, wherein the at least one external continuously-varying charging electric field is applied superimposed and simultaneously with, prior to, or subsequent to the fixed value constant electric field applied to the anode of the battery.

8. The method of claim 6, wherein the fixed value constant electric field comprises a fixed value constant current, a fixed value constant voltage, or combinations thereof.

9. The method of claim 8, wherein the fixed value constant current is applied to the anode until the battery reaches terminating charging voltage of the battery.

10. The method of claim 8, wherein the fixed value constant voltage is equal to the terminating charging voltage of the battery and is applied to the anode until the current of the battery decreases to a predetermined optimum capacity charge level of the battery.

11. The method of claim 1, further comprising:
adjusting the at least one external continuously-varying charging electric field parameters of amplitude and frequency for decreasing the charging time of the battery.

12. The method of claim 6, wherein the at least one external continuously-varying charging electric field is applied at a frequency of about 10 Hz to about 10,000 Hz.

13. The method of claim 6, wherein the at least one external continuously-varying charging electric field is applied at about a 50% duty cycle.

14. The method of claim 1, wherein the at least one external continuously-varying charging electric field parameters of amplitude, frequency, and shape are set at a predetermined optimum level for improving battery cell lifetime, cell charge capacity, cell discharge capacity, and cell charging time.

15. The method of claim 1, wherein charging is terminated when the battery charge reaches a predetermined percentage of full capacity.

16. The method of claim 1, wherein the rechargeable battery is a lithium-ion battery.

17. A system for charging a rechargeable battery, the system comprising:
a rechargeable battery;
means for applying an electric charge to the anode of the battery;
means for applying at least one external continuously-varying charging electric field to the anode of the battery; and
means for maintaining the voltage difference between the cathode and the anode of the battery below the critical voltage of the battery.

18. The system of claim 17, wherein the at least one external continuously-varying charging electric field is an oscillatory electric field, a random electric field, or combinations thereof.

19. The system of claim 17, wherein the at least one external continuously-varying charging electric field comprises a time-dependent voltage, a time-dependent current, or combinations thereof.

20. The system of claim 19, wherein the system further comprises a means for optionally applying a fixed value constant electric field and at least one external continuously-varying charging electric field to the anode of the battery.

21. The system of claim 20, wherein the at least one external continuously-varying charging electric field is applied superimposed and simultaneously with, prior to, or subsequent to the fixed value constant electric field applied to the anode of the battery.

22. The system of claim 20, wherein the fixed value constant electric field comprises a fixed value constant current, a fixed value constant voltage, or combinations thereof.

23. The system of claim 22, wherein the fixed value constant current is applied to the anode until the battery reaches terminating charging voltage of the battery.

24. The system of claim 22, wherein the fixed value constant voltage is equal to the terminating charging voltage of the battery and is applied to the anode until the current of the battery decreases to a predetermined optimum capacity charge level of the battery.

25. The system of claim 17, further comprising:
means for adjusting the at least one external continuously-varying charging electric field parameters of amplitude and frequency for decreasing the charging time of the battery.

26. The system of claim 20, wherein the at least one external continuously-varying charging electric field is applied at a frequency of about 10 Hz to about 10,000 Hz.

27. The system of claim 20, wherein the at least one external continuously-varying charging electric field is applied at about a 50% duty cycle.

28. The system of claim 17, wherein the at least one external continuously-varying charging electric field parameters of amplitude, frequency, and shape are set at a predetermined optimum level for improving battery cell lifetime, cell charge capacity, cell discharge capacity, and cell charging time.

29. The system of claim 17, wherein charging is terminated when the battery charge reaches a predetermined percentage of full capacity.

30. The system of claim 17, wherein the rechargeable battery is a lithium-ion battery.
